(19) United States
(12) Patent Application Publication
(10) Pub. No.: US 2006/0239291 A1
(43) Pub. Date: Oct. 26, 2006

(54) Method and apparatus for determining a best route within an ad-hoc communication system

(76) Inventors: Mark A. Birchler, Roselle, IL (US); Jeffrey D. Bonta, Arlington Heights, IL (US)

Correspondence Address: MOTOROLA, INC., 1303 EAST ALGONQUIN ROAD, IL01/3RD, SCHAUMBURG, IL, 60196, US

(21) Appl. No.: 11/114,660

(22) Filed: Apr. 26, 2005

(51) Int. Cl. H04J 3/22; H04L 12/26; H04J 3/14; H04J 1/16; H04J 3/16; H04L 12/56; H04L 12/28

(52) U.S. Cl. 370/437; 370/389; 370/465

(57) ABSTRACT

Signal-strength measurements are periodically made for all nodes within communication range of a node. The time-varying nature of the signal-strength measurements are taken into account prior to any node being used for routing purposes. More particularly, if the time-varying nature of a node's signal strength indicates that it is traveling at a high speed, the node is not utilized for routing purposes.

### FIELD OF THE INVENTION

The present invention relates generally to ad-hoc communication systems and in particular, to a method and apparatus for determining a best route within such communication systems.

### BACKGROUND OF THE INVENTION

In typical ad-hoc communication systems, data is transmitted from a source node to a destination node through intervening nodes. In order to determine a best route (i.e., the best intervening nodes) to utilize, ad-hoc communication systems must perform route discovery. Many forms of route discovery have been proposed for ad-hoc communication systems. For example, message flooding, location-based techniques, and systems employing overlay communication systems have all been proposed as techniques for discovering an appropriate route between a source and a destination node.

While the above-mentioned techniques do an adequate job in determining the best route between a source and a destination node, oftentimes the route is unreliable due to the mobile nature of many intervening nodes. More particularly, because nodes can take varied forms such as transceiver security tags attached to valuable assets such as lap top computers, golf carts equipped with wireless transceivers, or be embedded in wireless communication devices such as cellular telephones, nodes may be highly mobile. The highly-mobile nature of nodes may make any route chosen unreliable if an intervening node is highly mobile. Because of this, a need exists for a method and apparatus for determining a best route within an ad-hoc communication system that results in more reliable routes being utilized.

### BRIEF DESCRIPTION OF THE DRAWINGS

FIG. 1 is a block diagram of a communication system.

FIG. 2 is a block diagram of a node.

FIG. 3 illustrates the rate-of-change of signal strength for nodes over time.

FIG. 4 is a flow chart showing operation of the node of FIG. 2 during the collection of mobility data.

FIG. 5 is a flow chart showing operation of the node of FIG. 2 during route selection.

FIG. 6 is a flow chart showing the operation of the node of FIG. 2 during route maintenance.

### DETAILED DESCRIPTION OF THE DRAWINGS

To address the above-mentioned need, signal-strength measurements are periodically made for all nodes within communication range of a node. The time-varying nature of the signal-strength measurements are taken into account prior to any node being used for routing purposes. More particularly, if the time-varying nature of a node's signal strength indicates that it is traveling at a high speed, the node is not utilized for routing purposes.

The present invention encompasses a method comprising the steps of determining a time-varying nature of signals received from nodes and excluding nodes from routing data when the time-varying nature of the signals received from the nodes are above a threshold.

The present invention additionally encompasses a method for determining a best route within an ad-hoc communication system. The method comprises the steps of determining candidate intervening nodes existing between a source and a destination node, determining a speed of the candidate intervening nodes, and excluding candidate intervening nodes from becoming intervening nodes when their speed is too great. A best route is then determined between the source and the destination node utilizing non-excluded candidate intervening nodes.

The present invention additionally encompasses a method for determining a best route within an ad-hoc communication system. The method comprises the steps of determining intervening nodes existing between a source and a destination node, determining a speed of the intervening nodes, and when the speed of an intervening node is too great, notifying the source node, causing the source node to trigger route discovery.

The present invention encompasses an apparatus comprising logic circuitry determining candidate intervening nodes existing between a source and a destination node, determining a speed of the candidate intervening nodes, excluding candidate intervening nodes from becoming intervening nodes when their speed is too great, and determining a best route between the source and the destination node utilizing non-excluded candidate intervening nodes.

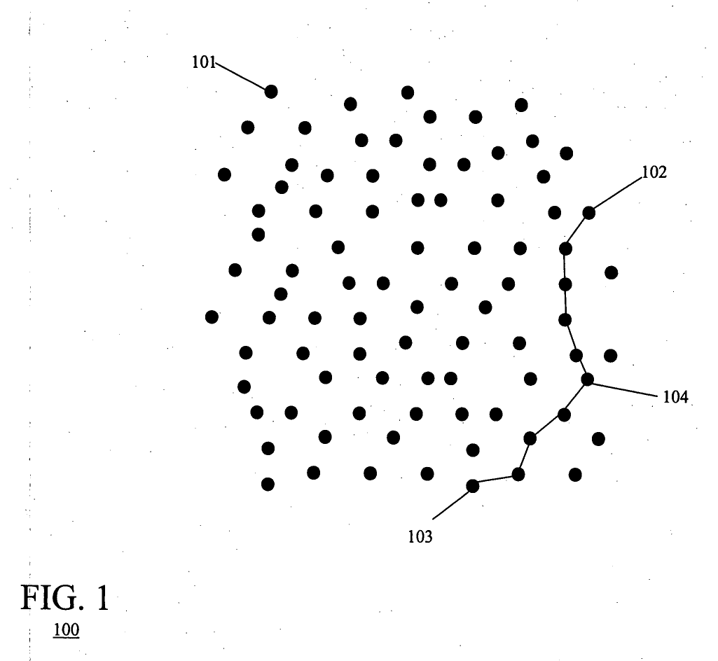

Turning now to the drawings, wherein like numerals designate like components, FIG. 1 is a block diagram of communication system 100. Communication system 100 preferably utilizes a communication system protocol defined by IEEE 802.11 ad-hoc protocol, however in alternate embodiments other system protocols may be used. Such protocols include, but are not limited to the 802.15.3 Wireless Personal Area Networks for High Data Rates standard or the IEEE 802.15.4 Low Rate Wireless Personal Area Networks standard. Communication system 100 includes a number of nodes (black circles) communicate with each other through wireless communication, and can be transportable (mobile) or they can be fixed in a given place. As discussed, nodes may comprise any number of forms including, but not limited to transceiver security tags attached to valuable assets such as lap top computers, embedded circuitry within wireless communication devices including cellular telephones.

When communication is desired between nodes that are not within communication range of each other, the transmissions are routed through intervening nodes. Thus, for example, if node 102 wishes to communicate to node 103, the communication will pass through intervening nodes 104 (only one intervening node labeled in FIG. 1). As discussed above, the highly-mobile nature of nodes may make any route chosen unreliable if an intervening node is highly mobile. In order to address this issue, in the preferred embodiment of the present invention signal-strength measurements are periodically made for all nodes within communication range. The time-varying nature of the signal-strength measurements are taken into account prior to any node being used for routing purposes. More particularly, if the time-varying nature of a node's signal strength indicates that it is traveling at a high speed relative to the measuring node, the node is not utilized for routing purposes.

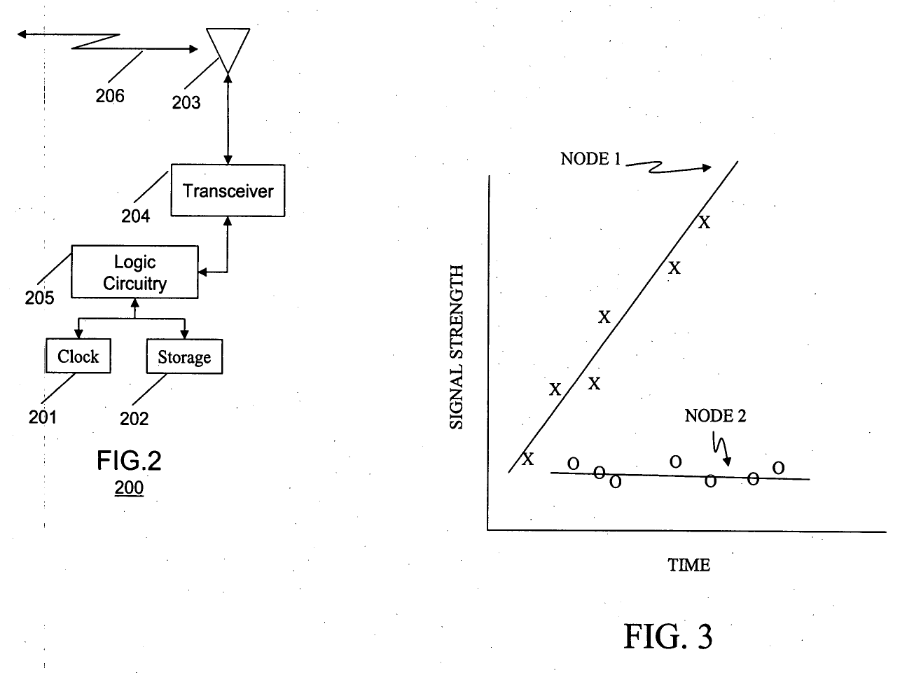

FIG. 2 is a block diagram of node 200 equipped to determine a best route based on the time-varying nature of nodes' signal-strength measurements. As shown, node 200 comprises antenna 203 coupled to transmitter/receiver (transceiver) 204, in turn, coupled to logic circuitry 205. Although various forms for antenna 203, transceiver 204, and logic circuitry 205 are envisioned, in a preferred embodiment of the present invention node 200 is formed from a Freescale Inc. MC13192 transceiver 204 coupled to a Motorola HC08 8-bit processor 205. In addition to the above-mentioned elements, node 200 comprises clock 201 and storage means 202.

As part of normal operating procedures, node 200 will periodically receive signals transmitted from other nodes. More particularly, all nodes periodically transmit, for example, a pilot signal which is received by transceiver 204. The pilot signal typically comprises the identification of the node transmitting the pilot. Once received, the pilot signal is analyzed by logic circuitry 205 to determine a signal strength of the received signal. In the preferred embodiment of the present invention a Received Signal Strength Indicator (RSSI) is utilized for speed determination, however in alternate embodiments of the present invention, other measurements may be utilized. For example, logic circuitry 205 may utilize such measurements as C/I+N or Doppler shift (assuming extremely accurate frequency synchronization between the nodes).

Once a signal-strength measurement has been made, clock 201 is accessed to determine a time of reception for the received signal, and database/storage 202 is updated with an entry comprising the node's ID, the signal-strength measurement, and a time the signal was received. When node 200 wishes to determine a best route to a destination node, it follows normal route-discovery techniques to determine candidate intervening nodes. Once all candidate intervening nodes are selected, certain intervening nodes are eliminated from consideration if their relative speed is too great. In the simplest case, a node's speed is determined via calculating a slope of the received signal strength as a function of time. A high slope value would suggest a relatively high rate of change between the nodes, thus implying that the sustainability of a route that used this high position dynamic node may be less than desirable. On the other hand, a node with a relatively flat slope would suggest a relatively low relative position dynamic, thus implying the potential for good sustainability for the route. In the preferred embodiment of the present invention node 200 chooses the best route from all remaining candidate intervening nodes. This is illustrated in FIG. 3.

FIG. 3 shows a graph of received signal strength versus time. Two nodes are shown for illustrative purposes. The first node (NODE 1) has increasing signal strength with time, as opposed to the second node (NODE 2) which has flat-to-slightly-decreasing signal strength over time. The slope of the best-fit-line for NODE 1 indicates that it is traveling at a high rate of speed, and thus will be precluded from any intervening node status. Contrary to NODE 1, NODE 2 has very little slope for the best-fit line, and hence, will be included as a candidate intervening node.

It should be noted that in the preferred embodiment of the present invention, even though the signal strength of a node may be increasing, the node may still be precluded for becoming an intervening node when its speed is too high. The contrary is also true. In other words, even though the signal strength of a node may be decreasing the node may still be utilized for an intervening node if it is not traveling at too great of a speed. Thus, even though NODE 1 has an increasing signal strength, and NODE 2 has a flat-to-slightly-decreasing signal strength, NODE 1 will be precluded because of its high rate of speed.

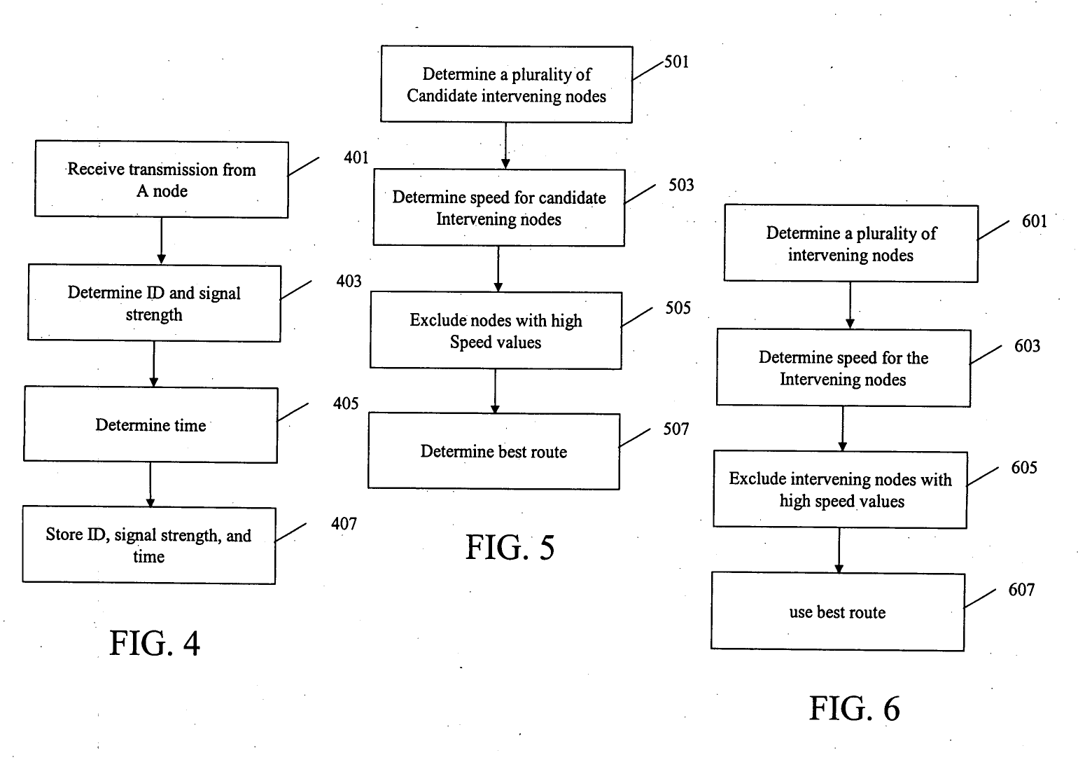

FIG. 4 is a flow chart showing operation of the node of FIG. 2 during the collection of mobility data. The logic flow begins at step 401 where transceiver 204 receives a transmission from a node. As discussed, the transmission may be a simple pilot broadcast transmitted from the node, or may alternatively be any other form of communication, such as, but not limited to control and/or data packets such as hello messages that are received by the measuring node.

At step 403, logic circuitry analyzes the transmission to determine a signal strength (e.g., RSSI) and an identification. Clock 201 is accessed at step 405 to determine the time for the received signal, and at step 407 the identification, time, and signal strength are stored in database 202. Thus database 202 comprises signal-strength measurements from all nodes (including candidate intervening nodes) and times that the signal-strength measurements were made.

FIG. 5 is a flow chart showing operation of the node of FIG. 2 during route selection. The logic flow begins at step 501 where logic circuitry 205 determines a plurality of candidate intervening nodes existing between a source and a destination node. As discussed, the intervening nodes are preferably determined via standard route-discovery algorithms. At step 503, logic circuitry 205 accesses database 202 to determine a speed for each candidate intervening nodes. As discussed above, a time-varying nature of an RSSI measurement and in particular a linear-best-fit technique for signal strength versus time for a candidate intervening node is utilized to determine a speed for the candidate intervening node. At step 505 logic circuitry 205 excludes candidate nodes from routing when they have a speed (i.e., the time-varying nature of their RSSI) greater than a threshold.

Finally, at step 507, the best route is determined utilizing the remaining candidate intervening nodes (i.e., the non-excluded candidate intervening nodes). A variety of methods may be used to choose a route. Typically, a route may be chosen that provides the shortest hop distance between the source and target node. This does not necessarily lead to the best route for all applications or services. Alternatively, a route may be chosen based on route metrics accumulated from each node in the route being evaluated. The accumulated route metrics may enable route selection that affords the highest data rate. Many other metrics are possible criteria for route selection. Other route selection techniques may base decisions on predictions of the quality of the route using local information about the possible next hops toward the destination.

While the above-describe procedures outline a novel method and apparatus for choosing a best route, it should be noted that the above techniques may be utilized for route maintenance as well. For example, if a route has been established, the movement of intervening nodes can be utilized to assure a quality link between the source and destination nodes. As an illustration, assume an intervening node suddenly begins moving. With this information, a node can determine that the moving node has the potential to cause the link to be broken. The moving node may then be excluded from being an intervening node, and substituted with another intervening node. This procedure is illustrated in FIG. 6.

FIG. 6 is a flow chart showing the operation of the node of FIG. 2 during route maintenance. It should be noted that the following process flow applies to all nodes that are actively involved in communicating between a source and a destination node. Thus, node 200 may be an intervening node, or may alternatively be the source or destination node. Regardless of the role node 200 takes, as part of route maintenance, the process steps of FIG. 6 will be periodically performed to assure a quality connection. The logic flow begins at step 601 where logic circuitry 205 determines a plurality of actual intervening nodes. As discussed, the intervening nodes are actively in the process of relaying information between a source and a destination node. At step 603, logic circuitry 205 accesses database 202 to determine a speed for each intervening nodes. As discussed above, the determination of a speed for a candidate intervening node is made by using a linear-best-fit technique for signal strength versus time for the particular node. Thus, database 202 is accessed to determine RSSI measurements and the time that the RSSI measurements were taken. This information is then utilized to determine a linear-best fit for signal strength versus time.

At step 605 intervening nodes are excluded having a speed that is greater than a threshold. Finally, at step 507, the best route is determined utilizing the remaining intervening nodes along with any candidate intervening nodes. More particularly, once an intervening node is determined to have exceeded the threshold for relative speed, the measuring node will generate a route error message back to the source node. This route error message can be used as a warning to all upstream nodes that the intervening node is moving too fast and that a new route needs to be established to the destination. The route error will trigger a new route discovery, thus restarting the process of determining new candidate intervening nodes to maintain the route. Thus, when the speed of an intervening node is too great, notifying the source node causes the source node to trigger route discovery.

While the invention has been particularly shown and described with reference to a particular embodiment, it will be understood by those skilled in the art that various changes in form and details may be made therein without departing from the spirit and scope of the invention. For example, it is envisioned that data will be periodically purged from database 202 in order to eliminate “stale” data points. The amount of time that the data is allowed to remain within database 202 may be a function of how static the environment is. For example, in a highly-mobile environment (e.g., transceivers fixed to golf carts) data may be eliminated from database 202 after it is 25 second old. However, in a more-static environment (e.g., asset tags fixed to personal computers) data may be eliminated from database after it is 1 minute old. Additionally, it is envisioned that any node in the route can generate and use speed information. For example, a node may generate its own speed information and provide it to the network. Decisions on whether to include a node as an intervening nodes may then be made on this information. It is intended that such changes come within the scope of the following claims.

1. A method comprising the steps of:
determining a time-varying nature of signals received from nodes; and
excluding nodes from routing data when the time-varying nature of the signals received from the nodes are above a threshold.

2. A method for determining a best route within an ad-hoc communication system, the method comprising the steps of:
determining candidate intervening nodes existing between a source and a destination node;
determining a speed of the candidate intervening nodes;
excluding candidate intervening nodes from becoming intervening nodes when their speed is too great; and
determining a best route between the source and the destination node utilizing non-excluded candidate intervening nodes.

3. The method of claim 2 wherein the step of determining the speed of the candidate intervening nodes comprises the step of determining a time-varying nature of a signal strength of the candidate intervening nodes.

4. The method of claim 3 wherein the step of determining the time-varying nature of the signal strength comprises the step of determining a time-varying nature of a received signal strength indication (RSSI).

5. The method of claim 4 wherein the step of determining the time-varying nature of the RSSI comprises the step of determining a slope of RSSI as a function of time.

6. The method of claim 2 further comprising the step of:
storing a signal-strength measurement and a time the signal-strength measurement was obtained.

7. The method of claim 6 wherein the step of determining the speed of the candidate intervening nodes comprises the step of accessing stored signal-strength measurements and times to determine the speed.

8. A method for determining a best route within an ad-hoc communication system, the method comprising the steps of:
determining intervening nodes existing between a source and a destination node;
determining a speed of the intervening nodes; and
when the speed of an intervening node is too great, notifying the source node, causing the source node to trigger route discovery.

9. The method of claim 8 wherein the step of determining the speed of the intervening nodes comprises the step of determining a time-varying nature of a signal strength of the intervening nodes.

10. The method of claim 9 wherein the step of determining the time-varying nature of the signal strength comprises the step of determining a time-varying nature of a received signal strength indication (RSSI).

11. The method of claim 10 wherein the step of determining the time-varying nature of the RSSI comprises the step of determining a slope of RSSI as a function of time.

12. The method of claim 11 further comprising the step of:
storing a signal-strength measurement and a time the signal-strength measurement was obtained.

13. The method of claim 12 wherein the step of determining the speed of the intervening nodes comprises the step of accessing stored signal-strength measurements and times to determine the speed.

14. An apparatus comprising:
logic circuitry determining candidate intervening nodes existing between a source and a destination node, determining a speed of the candidate intervening nodes, excluding candidate intervening nodes from becoming intervening nodes when their speed is too great, and determining a best route between the source and the destination node utilizing non-excluded candidate intervening nodes.

15. The apparatus of claim 14 further comprising:
a database containing signal-strength measurements from the candidate intervening nodes and times that the signal-strength measurements were made.

16. The apparatus of claim 14 wherein the speed of the candidate intervening nodes is determined by determining a time-varying nature of a signal strength of the candidate intervening nodes.

17. The apparatus of claim 16 wherein the time-varying nature of the signal strength comprises a time-varying nature of a received signal strength indication (RSSI).

18. The apparatus of claim 17 wherein the time-varying nature of the RSSI comprises a slope of RSSI as a function of time.
